(19) United States
(12) Patent Application Publication
(10) Pub. No.: US 2023/0084498 A1
(43) Pub. Date: Mar. 16, 2023

(54) DRIVING ASSISTANCE APPARATUS, DRIVING ASSISTANCE METHOD, AND STORAGE MEDIUM

(71) Applicant: CANON KABUSHIKI KAISHA, Tokyo (JP)

(72) Inventor: Yuya Horii, Kanagawa (JP)

(21) Appl. No.: 17/945,188

(22) Filed: Sep. 15, 2022

(30) Foreign Application Priority Data
Sep. 15, 2021 (JP) 2021-150306

(51) Int. Cl. B60W 50/14; B60W 40/04; B60W 30/18; G06V 20/58; B60R 1/26; B60R 1/24

(52) U.S. Cl. CPC B60W 50/14; B60W 40/04; B60W 30/18154; G06V 20/584; B60R 1/26; B60R 1/24; B60W 2050/143; B60W 2050/146; B60W 2420/42; B60R 2300/105; B60R 2300/8066

(57) ABSTRACT

A driving assistance apparatus comprises an image recognition unit configured to acquire an image of a traffic signal for an oncoming traffic lane from a rearward image capturing apparatus for capturing an image rearward of a vehicle, and in a case in which the vehicle is in a waiting state for turning across oncoming traffic at an intersection, to recognize a display state of the traffic signal for the oncoming traffic lane based on an image of the traffic signal for the oncoming traffic lane; a determination unit configured to determine, based on at least the display state of the traffic signal for the oncoming traffic lane that is recognized in the waiting state, whether or not a turning operation across the oncoming traffic lane is possible; and an information presentation unit configured to present information corresponding to the result of the determination to the driver.

### BACKGROUND OF THE INVENTION

### Field of the Invention

The present invention relates to a driving assistance apparatus for supporting a driving operation of a vehicle, a driving assistance method, and a storage medium.

Description of the Related Art

Japanese Patent Application Laid-Open No. 2018-172039 discloses a method of switching an angle of view of an image capturing apparatus to capture an image of a traffic signal for an oncoming traffic lane when waiting to turn right, and presenting a display state of the traffic signal for the oncoming traffic lane to a driver.

However, in a case in which a subject vehicle is turning right at an intersection and in a case in which the display state of a traffic signal for the oncoming traffic lane is not red, there is a possibility that an oncoming vehicle may enter the intersection. Even if the display state of the traffic signal for the traveling lane of the subject vehicle is green, in a case in which the display state of the traffic signal for an oncoming traffic lane is not yet red, the driver is required to pay attention to the movement of oncoming vehicles. In Japanese Patent Application Laid-Open No. 2018-172039, only the display state of the traffic signal for an oncoming traffic lane is presented to the driver, and it is not possible to determine whether or not the vehicle can safely make a right turn. Therefore, there is a possibility that a driver could make an error in judgment.

### SUMMARY OF THE INVENTION

A driving assistance apparatus according to one aspect of the present invention includes at least one processor or circuit configured to function as an image recognition unit configured to acquire an image of a traffic signal for an oncoming traffic lane from a rearward image capturing apparatus configured for capturing an image rearward of a vehicle, and in a case in which the vehicle is in a waiting state for turning across oncoming traffic at an intersection, to recognize a display state of the traffic signal for the oncoming traffic lane based on an image of the traffic signal for the oncoming traffic lane; a determination unit configured to determine, based on the display state of the traffic signal for the oncoming traffic lane that is recognized in the waiting state, whether or not a turning operation across the oncoming traffic lane is possible; and an information presentation unit configured to present information corresponding to the result of the determination to the driver.

Further features of the present invention will become apparent from the following description of embodiments with reference to the attached drawings.

### BRIEF DESCRIPTION OF THE DRAWINGS

FIG. 1 is a diagram for explaining a vehicle 10 according to a first embodiment.

FIG. 2 is a block diagram for explaining the constituent elements of a driving support apparatus 102 according to the first embodiment.

FIG. 3 is a diagram showing a presentation example of right turn information to a driver 500.

FIG. 4 is a flowchart for explaining an example of a driving support processing 400 performed by the driving assistance apparatus 102.

FIG. 5 is a diagram for explaining an image capturing angle of view of a rearward imaging apparatus 100 during straight traveling and an image capturing angle of view of the rearward imaging apparatus 100 when waiting to turn right.

FIG. 6 is a flowchart for explaining an example of right turn determination processing 600 performed in step S405 of FIG. 4.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

A driving assistance apparatus 102 according to the first embodiment can recognize the display state of a traffic signal for an oncoming traffic lane based on an image of a traffic signal for the oncoming traffic lane captured by a rearward image capturing apparatus 100 in a waiting state for turning across the oncoming traffic lane at an intersection (waiting for a right turn or a left turn). In such a waiting state, the driving assistance apparatus 102 can further determine whether or not a driving operation of turning across the oncoming traffic lane (a right turn or a left turn) can be safely performed based on the display state of the traffic light for the oncoming traffic lane.

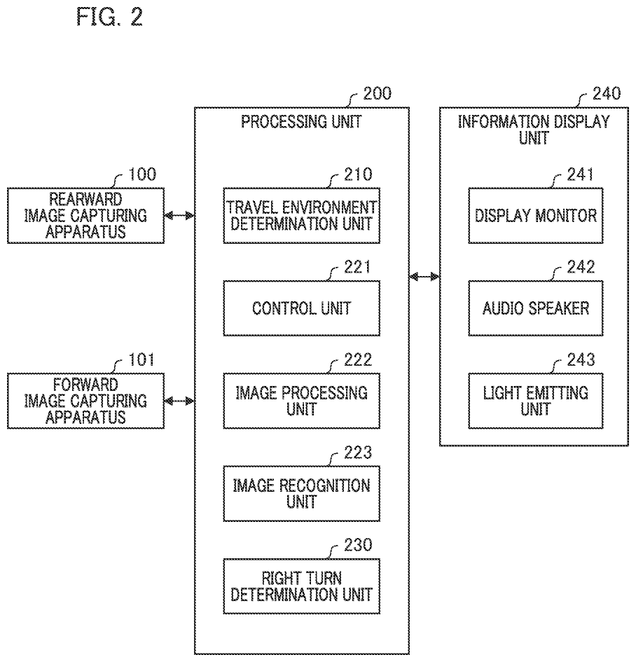

In addition, the driving assistance apparatus 102 can present information indicating whether or not a driving operation of turning across the oncoming traffic lane (a right turn or a left turn) can be safely performed to the driver by at least one of an image, a sound, or a light emission at an appropriate timing. Thereby, the driving assistance apparatus 102 can support safe and smooth driving operations (turning right or left) by the driver (particularly, novice and elderly drivers). The constituent elements of the driving assistance apparatus 102 will be explained with reference to FIG. 2.

Note that in traffic systems in Japan and other countries, waiting to turn across an oncoming traffic lane at an intersection means waiting to turn right, and a driving operation to turn across an oncoming traffic lane means a right turn. In contrast, in traffic systems in the United States and other countries, waiting to turn across an oncoming traffic lane at an intersection means waiting to turn left, and a driving operation to turn across an oncoming traffic lane means a left turn. Although the first embodiment explains an example in which the driving assistance apparatus 102 is applied to a traffic system such as that of Japan, the driving assistance apparatus 102 can also be applied to a traffic system such as that of the United States. In an example in which the driving assistance apparatus 102 is applied to a traffic system such as that of the United States, a right turn is replaced with a left turn.

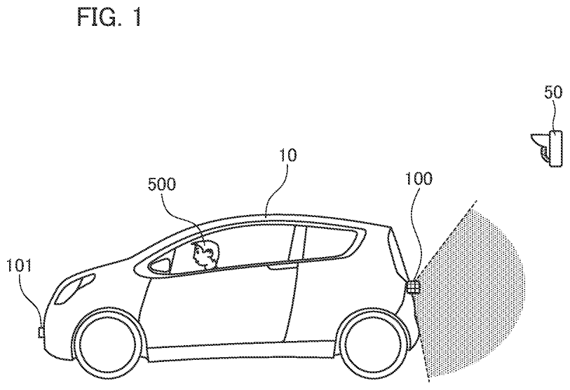

FIG. 1 is a diagram for explaining a vehicle 10 according to a first embodiment.

A vehicle 10 includes a rearward image capturing apparatus 100, a forward image capturing apparatus 101, and a driving assistance apparatus 102. The rearward image capturing apparatus 100 and the forward image capturing apparatus 101 are connected to the driving assistance apparatus 102 shown in FIG. 2. The rearward image capturing apparatus 100 is an image capturing apparatus mounted to a rear portion of the vehicle 10, and captures an image rearward of the vehicle 10. The forward image capturing apparatus 101 is an image capturing apparatus mounted to a front portion of the vehicle 10, and captures an image forward of the vehicle 10. The rearward image capturing apparatus 100 is configured so as to enable the capture of an image range required for the electronic mirror display at a normal angle of view in a case in which the vehicle 10 is traveling in a forward direction, and configured so as to enable the capture of an image range required for the rear-view monitor at a normal angle of view in a case in which the vehicle 10 is traveling in a rearward direction.

Further, the rearward image capturing apparatus 100 is configured so as to enable the capture of an image of a range that includes a traffic signal for the oncoming traffic lane 50 at a wide angle of view in a case of a right turn waiting state at an intersection. The forward image capturing apparatus 101 is configured so as to enable the capture of an image of a range that includes a traffic signal for the traveling lane 51 at a normal angle of view. Note that any of the rearward image capturing apparatus 100 and the forward image capturing apparatus 101 may be constituent elements of the driving assistance apparatus 102, or may be an apparatus separate from the driving assistance apparatus 102.

The vehicle 10 in the first embodiment is, for example, a passenger car or the like, and can be moved to an arbitrary location, for example, by a driver 500 riding thereon. Further, the driver 500 need not ride in the vehicle 10 and may be a driver 500 (operator) that remotely operates the vehicle 10, and the driving assistance explained in the first embodiment includes driving assistance in such a remote operation.

Next, the constituent elements of the driving assistance apparatus 102 according to the first embodiment will be explained with reference to FIG. 2. The driving assistance apparatus 102 includes a processing unit 200 and an information presentation unit 240. In the first embodiment, although an example in which the processing unit 200 and the information presentation unit 240 are mounted on the vehicle 10 will be given, in a case in which the vehicle 10 is remotely controlled, the information presentation unit 240 may be mounted on an external apparatus that controls the vehicle 10 remotely.

The processing unit 200 includes a memory configured to store a program for implementing the functions described hereinafter, and a computer configured to execute the program stored in the memory. A computer included in the processing unit 200 is configured by an electronic circuit such as a microcomputer, a Central Processing Unit (CPU), or a microprocessor.

The processing unit 200 further includes a travel environment determination unit 210, a control unit 221, an image processing unit 222, an image recognition unit 223, and a right turn determination unit 230. Each of the travel environment determination unit 210, the control unit 221, the image processing unit 222, the image recognition unit 223, and the right turn determination unit 230 is configure by an electronic circuit to implement the functions described below. Note that each of the travel environment determination unit 210, the control unit 221, the image processing unit 222, the image recognition unit 223, and the right turn determination unit 230 may be configured independently of the processing unit 200.

The travel environment determination unit 210 performs communication with an in-vehicle Electronic Control Unit (ECU) mounted on the vehicle 10 via an interface such as a Controller Area Network (CAN), and acquires travel information of the vehicle 10. The travel information of the vehicle 10 includes, for example, a position of the vehicle 10, a speed of the vehicle 10, an operation state of the direction indicator of the vehicle 10, and a steering angle of a steering wheel 303.

A position (absolute coordinate values consisting of the latitude and longitude) of the vehicle 10 is detected by, for example, a GPS (Global Positioning System) receiver. The travel environment determination unit 210 determines whether or not the vehicle 10 is in a waiting state (right turn waiting state) for turning across an oncoming traffic lane at an intersection based on the acquired travel information. The travel environment determination unit 210 determines whether or not the vehicle 10 has completed a right turn in a case in which the vehicle 10 is in the right turn waiting state, and whether or not the right turn waiting state has been released. Note that whether or not the vehicle 10 is in right turn waiting state, whether or not the vehicle 10 has completed the right turn, and whether or not the right turn waiting state has been released may be determined based on a manual operation by the driver 500.

The control unit 221 (switching control unit) controls the rearward image capturing apparatus 100 and the forward image capturing apparatus 101. For example, the control unit 221 can control the image capturing angle of view of the rearward image capturing apparatus 100 and the image capturing angle of view of the forward image capturing apparatus 101 based on the determination result of the travel environment determination unit 210. The image processing unit 222 performs a predetermined image processing (including image capturing angle of view cropping processing, distortion correction processing, and the like) on an image captured by the rearward image capturing apparatus 100. In addition, a predetermined image processing (including image capturing angle of view cropping processing, distortion correction processing, and the like) is also performed on images captured by the forward image capturing apparatus 101.

The image recognition unit 223 recognizes the display status of the traffic signal for the oncoming traffic lane 50 based on the image captured by the rearward image capturing apparatus 100. Here, the display state of the traffic signal for the oncoming traffic lane 50 includes, for example, whether or not the traffic signal for the oncoming traffic lane 50 is displaying red, yellow, or green, and whether or not the traffic signal for the oncoming traffic lane 50 is displaying a right turn arrow. The image recognition unit 223 further recognizes the display state of the traffic signal for the oncoming traffic lane 51 based on the image captured by the forward image capturing apparatus 101, and detects whether or not an oncoming vehicle 11 entering the intersection is present and the speed of the oncoming vehicle 11 entering the intersection.

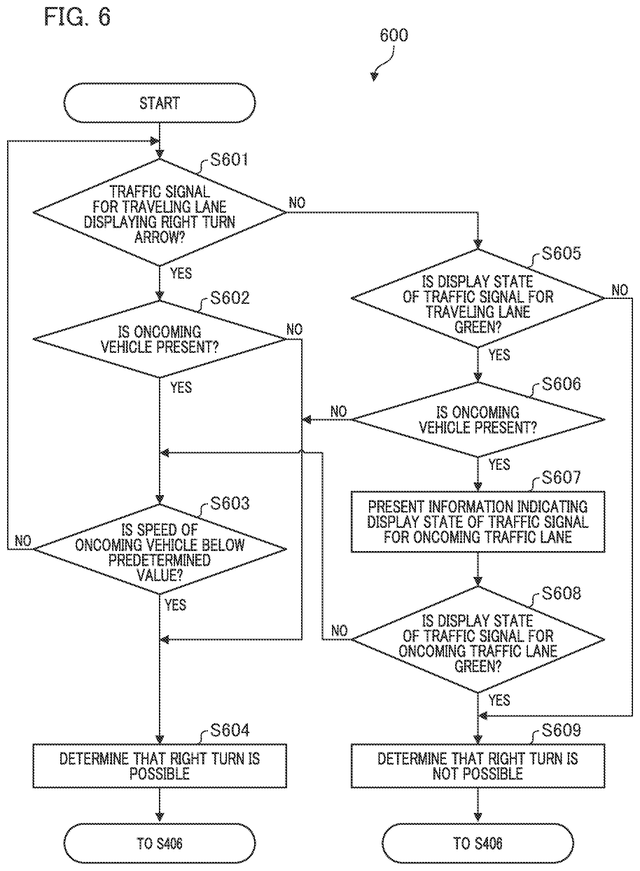

Note that whether or not an oncoming vehicle 11 entering the intersection is present, and the speed of the oncoming vehicle 11 entering the intersection may be determined by using, for example, a Light Detection And Ranging (LiDAR) sensor or Time Of Flight (TOF) sensor. The right turn determination unit 230 performs right turn determination processing to determine whether or not the vehicle 10 can safely turn right. Note that the right turn determination processing will be explained with reference to the flow chart of FIG. 6.

The information presentation unit 240 includes a display monitor 241, an audio speaker 242, and a light emitting unit 243. The information display unit 240 presents (notifies) information indicating the display state of the traffic signal for the oncoming traffic lane 50 to the driver 500, and presents (notifies) information indicating whether or not the vehicle 10 can safely turn right to the driver 500. The display monitor 241 includes, for example, an electronic room mirror and a rear-view monitor. Information indicating the display state of the traffic signal for the oncoming traffic lane 50, and information indicating whether or not the vehicle 10 can safely turn right, is displayed on at least one of the electronic room mirror and the rear-view monitor.

A display unit that operates as an electronic room mirror is provided, for example, in an upper stage in front of the driver's seat of the vehicle 10. A display unit that operates as a rear-view monitor is provided, for example, in the middle or lower stage in front of the driver's seat of the vehicle 10. The rear-view monitor can, for example, display an image captured by the rearward image capturing apparatus 100 in a state in which the vehicle 10 is driven in reverse. The rear-view monitor can also be connected to a car navigation system, for example, and display a map and the like.

The rearward image capturing apparatus 100 can change the angle of view, and can be switched to a wide angle so that image capturing can be performed up to the upper area in which the traffic signal for the oncoming traffic lane 50 is positioned, as shown in FIG. 1. The rearward image capturing apparatus 100 captures an image of a relatively narrow angle of view range rearward at high resolution at the time of the normal travel of the vehicle 10, and the captured image can be displayed on an electronic room mirror or the like. In addition, in a case in which the travel environment determination unit 210 determines that the vehicle 10 is in a right turn waiting state, the angle of view of the rearward image capturing apparatus 100 is switched by the control unit 221 (switching control unit) to a relatively wide angle of view that captures a range that includes the traffic signal for the oncoming traffic lane 50. In addition, the image of the traffic signal for the oncoming traffic lane 50 captured by the rearward image capturing apparatus 100 is displayed on an electronic room mirror or the like.

The driving assistance apparatus 102 may be connected to a plurality of rearward image capturing apparatuses 100. In a case in which a plurality of rearward image capturing apparatuses 100 are connected to the driving assistance apparatus 102, the plurality of rearward image capturing apparatuses 100 may be switched instead of switching the image capturing angle of view. The plurality of rearward image capturing apparatuses 100 includes, for example, a first rearward image capturing apparatus that captures an image of a range that includes a traffic signal for the oncoming traffic lane 50 in a case in which the vehicle 10 is in a right turn waiting state. In addition, a second rearward image capturing apparatus that captures an image of a range (including a rear vehicle) that is different from the first rearward image capturing apparatus at an angle of view that is different from that of the first rearward image capturing apparatus is included.

The plurality of rearward image capturing apparatuses 100 may further include a third rearward image capturing apparatus that captures an image of a range that includes a portion of the rear of the vehicle 10 and the ground at the rear of the vehicle 10 at the time the vehicle 10 is in reverse. The information presentation unit 240 may cause an image that has been captured by the second rearward image capturing apparatus to be displayed on, for example, an electronic room monitor, and at the time the vehicle 10 is in reverse, an image captured by the third rearward image capturing apparatus may be displayed on, for example, a rear-view monitor.

The forward image capturing apparatus 101 is capable of capturing an image of a range that includes a traffic signal for the traveling lane 51 that is disposed in the front of the vehicle 10 and on the traveling lane side, and an oncoming vehicle 11 that enters the intersection. Note that the forward image capturing apparatus 101 may be used as an image capturing apparatus for a drive recorder. Instead of providing, respectively, a forward image capturing apparatus 101 and a rearward image capturing apparatus 100, one image capturing apparatus that is capable of capturing an image both forward and rearward, for example, with an image capturing angle of view of 360 degrees, may be provided on the roof or the like of the vehicle 10.

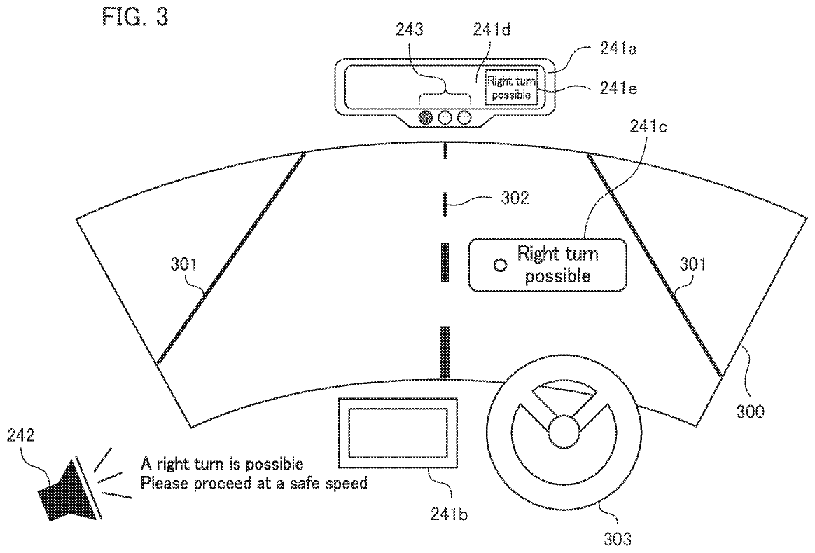

FIG. 3 is a diagram showing a presentation example of right-turn information to the driver 500 in the vehicle 10. In FIG. 3, reference numeral 300 denotes a front window, 301 denotes lines indicating a traveling lane, 302 denotes a center line, and 303 denotes a steering wheel.

As shown in FIG. 3, the display monitor 241 includes, for example, an electronic room mirror 241a, and a rear-view monitor 241b that also serves as a display unit for the car navigation system, as described above. Note that the display monitor 241 may include, for example, a Heads-Up Display (HUD) 241c that projects and displays an image on the front window, an electronic window with a transparent display incorporated into a window, or an instrument panel.

The display monitor 241 displays an image 241d of the traffic signal for the oncoming traffic lane 50 captured by the rearward image capturing apparatus 100 and information 241e indicating whether or not the vehicle 10 can safely turn right, for example, on at least one of the electronic room mirror, the rear-view monitor 241b, and the HUD 241c. Further, the audio speaker 242 may present (notify) a message such as “The traffic signal for the oncoming traffic lane has turned red.” or it may present (notify) a message such as “A right turn is possible. Please proceed at a safe speed.”

The light emitting unit 243 includes, for example, a three-color light emitting element (for example, a Light Emitting Diode (LED)) of red, yellow, and green. For example, although the light emitting unit 243 is in a non-lighting state in a normal state, the light emitting unit 243 may emit light in a color corresponding to the display state of the traffic signal for the oncoming traffic lane 50 in a right turn waiting state. Alternatively, the light emitting unit 243 may emit light in a color that indicates a right turn is possible (for example, green) if a right turn is possible, and may emit light in a color that indicates a right turn is not possible (for example, red) if a right turn is not possible. In addition to the presentation of information by a color, the light-emitting unit 243 may present whether or not the right turn can be performed safely by lighting or flashing.

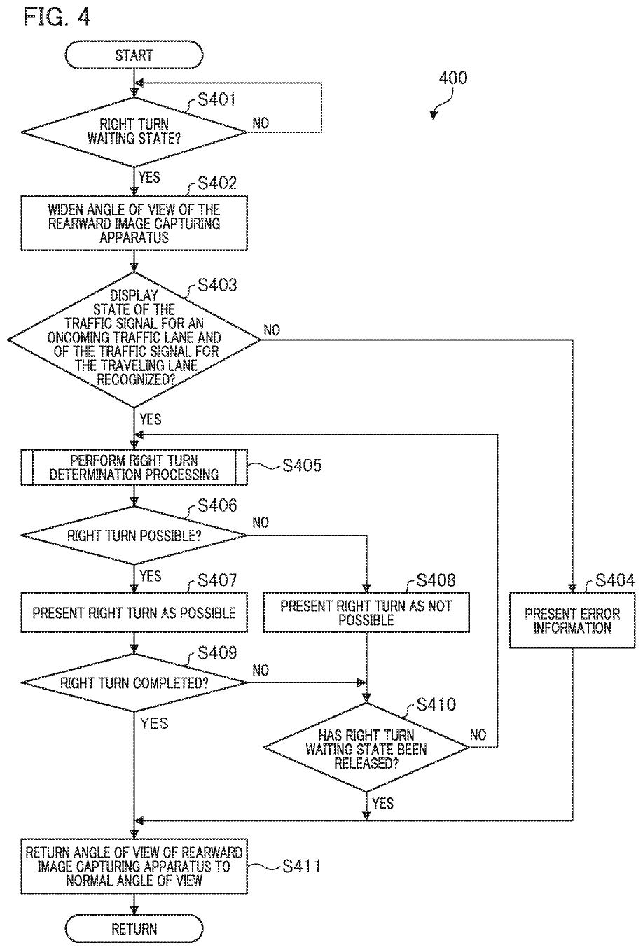

Next, an example of the driving assistance processing 400 performed by the driving assistance apparatus 102 will be explained with reference to the flowchart of FIG. 4. The driving assistance processing 400 shown in FIG. 4 is controlled by a computer in the processing unit 200 executing a program stored in a memory in the processing unit 200. At the time of the start of the driving assistance processing 400, a power source (for example, an engine or a motor) of the vehicle 10 is in a starting state, and the rearward image capturing apparatus 100 is capturing an image rearward of the vehicle 10 at an angle of view required for an image display of the electronic room mirror 241a. The forward image capturing apparatus 101 captures an image forward of the vehicle 10.

In step S401, the travel environment determination unit 210 determines whether or not the vehicle 10 is in a right turn waiting state at the intersection. For example, in a case in which the position of the vehicle 10 is in or near an intersection, and the speed of the vehicle 10 is below a predetermined speed (for example, 10 km/h), the travel environment determination unit 210 determines that the vehicle 10 is in a right turn waiting state at an intersection. For example, in a case in which the position of the vehicle 10 is in or near an intersection, and the direction indicator of the vehicle 10 is in an operation state indicating a right turn, the travel environment determination unit 210 determines that the vehicle 10 is in a right turn waiting state at the intersection.

In a case in which the vehicle 10 is determined to be in a right turn waiting state at an intersection (“YES” in step S401), the driving assistance processing 400 proceeds to step S402. In a case in which it is determined that the vehicle 10 is not in a right turn waiting state at the intersection (“NO” in step S401), the driving assistance processing 400 repeats the processing of S401 until it is determined that the vehicle 10 is in the right turn waiting state at the intersection.

In step S402, the control unit 221 widens the image capturing angle of view of the rearward image capturing apparatus 100 so that the traffic signal 50 for the oncoming traffic lane enters the image capturing angle of view of the rearward image capturing apparatus 100. By widening the image capturing angle of view of the rearward image capturing apparatus 100, the rearward image capturing apparatus 100 can capture an image of a range that includes the traffic signal 50 for the oncoming traffic lane. Thereby, in step S402, it is possible to perform control so as to change the angle of view of the rearward image capturing apparatus 100 in accordance with whether or not the vehicle 10 is in a right turn waiting state at the intersection.

The image processing unit 222 performs predetermined image processing (including image capturing angle of view cropping processing, distortion correction processing, and the like) with respect to an image captured by the rearward image capturing apparatus 100. Further, a predetermined image processing (including image capturing angle of view cropping processing, distortion correction processing, and the like) is also performed on an image captured by the forward image capturing apparatus 101.

In step S403 (image recognition step), the image recognition unit 223 analyzes the image captured by the rearward image capturing apparatus 100, and performs image recognition processing to recognize at least the display status of the traffic signal 50 for the oncoming traffic lane. In step S403, the image recognition unit 223 further analyzes the image captured by the forward image capturing apparatus 101, and performs image recognition processing to recognize the display state of the traffic signal for the traveling lane 51. In a case in which the display status of the traffic signal for the oncoming traffic lane 50 and the traffic signal for the traveling lane 51 is recognized (“YES” in step S403), the driving assistance processing 400 proceeds to step S405. In a case in which the display status of the traffic signal for the oncoming traffic lane 50 and the traffic signal for the traveling lane 51 is not recognized (“NO” in step S403), the driving assistance processing 400 proceeds to step S404.

In step S404, the information presentation unit 240 presents (notifies) a predetermined error information (for example, information indicating that the display status of at least one of the traffic signal for the oncoming traffic lane 50 and the traffic signal for the traveling lane 51 has not been recognized) to the driver 500. The information presentation unit 240 presents (notifies) the predetermined error information to the driver 500 by using at least one of the display monitors 241, the audio speaker 242, and the light emitting unit 243. Then, the driving assistance processing 400 proceeds to step S411 without determining whether or not the right turn can be safely performed.

In step S405, the right turn determination unit 230 performs right turn determination processing to determine whether or not the vehicle 10 can safely turn right. Note that the right turn determination processing performed in step S405 will be explained with reference to the flowchart of FIG. 6.

In step S406 (determination step, determination unit), whether or not the vehicle 10 can safely turn right is determined based on the results of the right turn determination processing 600 performed in step S405. If the right turn determination processing 600 determines that a right turn is possible (“YES” in step S406), the driving assistance processing 400 proceeds to step S407. “A right turn is possible” means that the vehicle 10 can safely turn right. If the right turn determination processing 600 determines that a right turn is not possible (“NO” in step S406), the driving assistance processing 400 proceeds to step S408. “A right turn is not possible” indicates that the vehicle 10 cannot safely turn right.

In step S407 (information presentation step), the information presentation unit 240 presents to the driver 500 that a right turn is possible by using at least one of the display monitor 241, the audio speaker 242, and the light emitting unit 243. Thereafter, the driving assistance processing 400 proceeds to step S409.

In step S408 (information presentation step), the information presentation unit 240 presents to the driver 500 that a right turn is not possible by using at least one of the display monitor 241, the audio speaker 242, and the light emitting unit 243. Thereafter, the driving assistance processing 400 proceeds to step S410.

In step S409, the travel environment determination unit 210 determines whether or not the vehicle 10 has completed a right turn. For example, in a case in which the vehicle 10 is traveling from an intersection in the direction of a right turn, and the speed of the vehicle 10 is above a predetermined speed (for example, 10 km/h), and the direction indicator of the vehicle 10 is not in an operation state indicating a right turn, the travel environment determination unit 210 determines that vehicle 10 has completed the right turn. Or, for example, in a case in which the vehicle 10 is traveling from an intersection in the direction of a right turn, and the speed of the vehicle 10 is above a predetermined speed (for example, 10 km/h), and the steering angle of the steering wheel 303 has been reduced to a predetermined angle (for example, 10 degrees) or less, the travel environment determination unit 210 may determine that vehicle 10 has completed the right turn.

Note that in a case in which the steering angle of the steering wheel 303 has changed to a predetermined angle (for example, 10 degrees) or less, the steering angle of the steering wheel 303 can be replaced in a case in which the steering angle of the steering wheel 303 changes from a large angle (for example, 45 degrees) to a small angle (for example, 10 degrees) by a predetermined threshold (for example, 35 degrees) or more. If it is determined that vehicle 10 has completed a right turn (“YES” in step S409), the driving assistance processing 400 proceeds to step S411. If it is determined that vehicle 10 has not completed a right turn (“NO” in step S409), the driving assistance processing 400 proceeds to step S410.

In step S410, the travel environment determination unit 210 determines whether or not the right turn waiting state of the vehicle 10 has been released. For example, in a case in which the path of the vehicle 10 is changed to the travel lane in which the vehicle 10 was traveling prior to the vehicle 10 entering the right turn waiting state, the travel environment determination unit 210 determines that the right turn waiting state of the vehicle 10 has been released. For example, in a case in which the path of the vehicle 10 is changed to the travel lane in which the vehicle 10 was traveling prior to the vehicle 10 entering the right turn waiting state, and the direction indicator of the vehicle 10 is not in an operation state indicating a right turn, the travel environment determination unit 210 determines that the right turn waiting state of the vehicle 10 has been released.

In a case in which the right turn waiting state of the vehicle 10 is determined to have been released (“YES” in step S410), the driving assistance processing 400 proceeds to step S411. In a case in which the right turn waiting state of the vehicle 10 is determined to not have been released (“NO” in step S410), the driving assistance processing 400 returns to step S405. In step S411, the control unit 221 returns the image capturing angle of view of the rearward image capturing apparatus 100 from the wide angle of view in which the traffic signal for the oncoming traffic lane 50 enters to the normal angle of view. Thereafter, the driving assistance processing 400 returns to step S401 to assist in turning right at the next intersection.

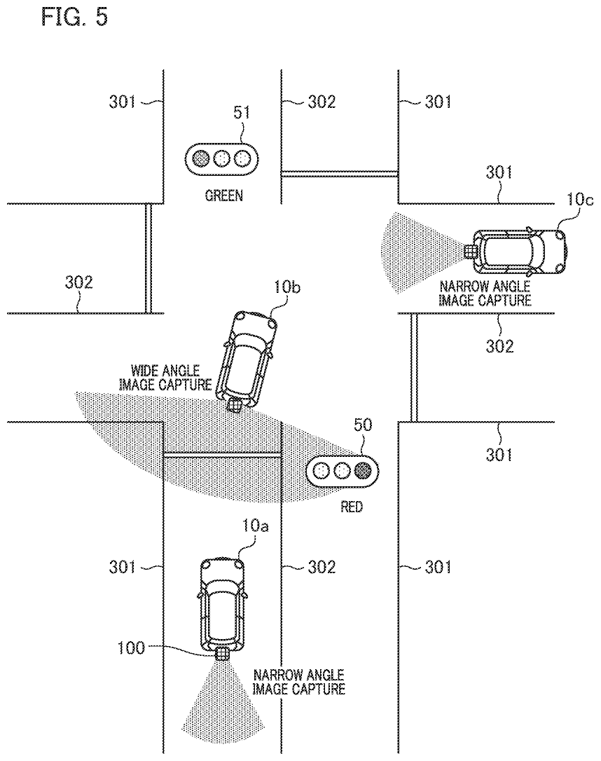

Next, an image capturing angle of view of the rearward imaging apparatus 100 at the time of straight traveling and an image capturing angle of view of the rearward imaging apparatus 100 in a right turn waiting state will be explained with reference to FIG. 5. As shown in FIG. 5, in a case in which the vehicle 10 is in a normal travel state (straight traveling state) 10a, the rearward image capturing apparatus 100 is performing rearward image capturing at a relatively narrow angle of view required for image display of the electronic room mirror. In a case in which the vehicle 10 is in the right turn waiting state 10b at an intersection, the rearward image capturing apparatus 100 switches the image capturing angle of view to a wide angle of view and performs capture of an image of the traffic signal for the oncoming traffic lane 50. In a case in which the vehicle 10 is in the state 10c in which the vehicle 10 has completed a right turn, the rearward image capturing apparatus 100 returns the image capturing angle of view from the wide angle of view to the normal angle of view.

Next, the right turn determination processing 600 performed in step S405 of FIG. 4 will be explained with reference to the flowchart of FIG. 6. The right turn determination processing 600 shown in FIG. 6 is controlled by a computer in the processing unit 200 executing a program stored in a memory in the processing unit 200.

In step S601, the right turn determination unit 230 determines whether or not the traffic signal for the traveling lane 51 is displaying a right turn arrow, based on the image recognition result of the image captured by the forward image capturing apparatus 101. In a case in which it is determined that the traffic signal for the traveling lane 51 is displaying a right-turn arrow (“YES” in step S601), the right turn determination processing 600 proceeds to step S602. In a case in which it is determined that the traffic signal for the traveling lane 51 is not displaying a right-turn arrow (“NO” in step S601), the right turn determination processing 600 proceeds to step S605.

In step S602, the right turn determination unit 230 determines whether or not an oncoming vehicle 11 entering the intersection is present based on the image recognition result of the image captured by the forward image capturing apparatus 101. In a case in which it is determined that an oncoming vehicle 11 entering the intersection is present (“YES” in step S602), the right turn determination processing 600 proceeds to step S603. In a case in which it is determined that an oncoming vehicle 11 entering the intersection is not present (“NO” in step S602), the vehicle 10 can safely turn right. Accordingly, the right turn determination processing 600 proceeds to step S604 without presenting information indicating the display state of the traffic signal for the oncoming traffic lane 50 to the driver 500.

In step S603, the right turn determination unit 230 determines whether or not the speed of the oncoming vehicle 11 entering the intersection is equal to or less than a predetermined value (for example, 5 km/h) based on the image recognition result of the image captured by the forward image capturing apparatus 101. In a case in which it is determined that the speed of the oncoming vehicle 11 entering the intersection is equal to or less than a predetermined value (“YES” in step S603), the possibility that the oncoming vehicle 11 will travel directly through the intersection is considered to be low.

Because it is possible to avoid the oncoming vehicle 11 even if it should continue straight ahead, the vehicle 10 can safely turn right. Accordingly, the right turn determination processing 600 proceeds to step S604 without presenting information indicating the display state of the traffic signal for the oncoming traffic lane 50 to the driver 500. In a case in which it is determined that the speed of the oncoming vehicle 11 entering the intersection is not equal to or less than the predetermined value (“NO” in step S603), the oncoming vehicle 11 may be ignoring the signal and is a danger, and therefore the right turn determination processing 600 returns to step S601.

In step S604, the right turn determination unit 230 determines that a right turn is possible. “A right turn is possible” means that the vehicle 10 can safely turn right. Thereafter, the right turn determination processing 600 proceeds to step S406 in FIG. 4.

In step S605, the right turn determination unit 230 determines whether or not the display state of the traffic signal for the traveling lane 51 is green based on the image recognition result of the image captured by the forward image capturing apparatus 101. In a case in which the display state of the traffic signal for the traveling lane 51 is green (“YES” in step S605), the right turn determination processing 600 proceeds to step S606. In a case in which the display state of the traffic signal for the traveling lane 51 is not green (“NO” in step S605), because it is not possible for the vehicle 10 to enter the intersection, the right turn determination processing 600 proceeds to step S609.

In step S606, the right turn determination unit 230 determines whether or not an oncoming vehicle 11 entering the intersection is present based on the image recognition result of the image captured by the forward image capturing apparatus 101. In a case in which it is determined that an oncoming vehicle 11 entering the intersection is present (“YES” in step S606), the right turn determination processing 600 proceeds to step S607. In a case in which it is determined that an oncoming vehicle 11 entering the intersection is not present (“NO” in step S606), the vehicle 10 can safely turn right. Therefore, the right turn determination processing 600 proceeds to step S604 without the information display unit 240 presenting information to the driver 500 indicating the display state of the traffic signal for the oncoming traffic lane 50.

In step S607, the right turn determination unit 230 instructs the information display unit 240 to present information to the driver 500 indicating the display state of the traffic signal for the oncoming traffic lane 50. The information presentation unit 240 presents information indicating the display state of the traffic signal for the oncoming traffic lane 50 to the driver 500 by using at least one of the display monitor 241, the audio speaker 242, and the light emitting unit 243.

In step S608, the right turn determination unit 230 determines whether or not the display state of the traffic signal for the oncoming traffic lane 50 is green based on the image recognition result of the image captured by the rearward image capturing apparatus 100. In a case in which the display state of the traffic signal for the oncoming traffic lane 50 is determined to be green (“YES” in step S608), the right turn determination processing 600 proceeds to step S609. In a case in which the display state of the traffic signal for the oncoming traffic lane 50 is determined to be yellow or red (“NO” in step S608), the right turn determination processing 600 proceeds to step S603. Then, in step S603, the right turn determination unit 230 determines whether or not the speed of the oncoming vehicle 11 entering the intersection is equal to or less than a predetermined value (for example, 5 km/h).

In step S609, the right turn determination unit 230 determines that a right turn is not possible. “A right turn is not possible” means that the vehicle 10 cannot safely turn right. Thereafter, the right turn determination processing 600 proceeds to step S406 in FIG. 4.

As explained above, in the first embodiment, it is possible to determine in step S602 or step S606 whether or not a right turn can be safely performed based on the presence or absence of an oncoming vehicle 11 entering the intersection. In step S603, whether or not the vehicle 10 can safely turn right based on the speed of an oncoming vehicle 11 in the oncoming traffic lane can be determined. Furthermore, in step S601, whether or not the vehicle 10 can safely turn right can be determined based on the display state of the traffic signal for the traveling lane 51. Thereby, according to the first embodiment, the driver 500 can assess the display state of a traffic signal for an oncoming traffic lane 50 and whether or not the vehicle 10 can safely turn right, without performing any excessive movements such as looking backward, and can perform a right turn safely and smoothly.

Note that as described above, the rearward image capturing apparatus 100 may be a wide-angle image capturing apparatus for a rear-view monitor, provided that it is capable of capturing images of the traffic signal for an oncoming traffic lane 50. In a case in which the rearward image capturing apparatus 100 is a wide-angle image capturing apparatus for a rear-view monitor, the operation of the wide-angle image capturing apparatus may be stopped during normal travel, and control for operating the wide-angle image capturing apparatus may be performed at the time of turning right at an intersection. For example, in step S402 of FIG. 4, switching to a wide-angle image capturing apparatus may be performed instead of switching an image capturing angle of view. Further, in a state in which the vehicle 10 has completed the right turn, the image capturing operation of the wide-angle image capturing apparatus may be stopped. For example, in step S411 of FIG. 4, the operation of the wide-angle image capturing apparatus may be stopped instead of returning the angle of view from wide-angle to narrow-angle.

In addition, as described above, the first embodiment assumes, for example, the Japanese traffic system and is premised on left-hand traffic (right-hand drive), but the first embodiment can also be applied to right-hand traffic (left-hand drive). In a case in which the first embodiment is applied to right-hand traffic (left-hand drive), the driving assistance apparatus 102 in the first embodiment is the driving assistance apparatus 102 that assists in a driving operation in a case of turning left at an intersection, and “right” in the first embodiment should be read as “left”.

### Second Embodiment

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions. In addition, as a part or the whole of the control according to the embodiments, a computer program realizing the function of the embodiments described above may be supplied to the driving assistance apparatus through a network or various storage media. Then, a computer (or a CPU, an MPU, or the like) of the driving assistance apparatus may be configured to read and execute the program. In such a case, the program and the storage medium storing the program configure the present invention.

This application claims the benefit of Japanese Patent Application No. 2021-150306 filed on Sep. 15, 2021, which is hereby incorporated by reference herein in its entirety.

What is claimed is:

1. A driving assistance apparatus, comprising at least one processor or circuit configured to function as:
an image recognition unit configured to acquire an image of a traffic signal for an oncoming traffic lane from a rearward image capturing apparatus for capturing an image rearward of a vehicle, and in a case in which the vehicle is in a waiting state for turning across oncoming traffic at an intersection, to recognize a display state of the traffic signal for the oncoming traffic lane based on an image of the traffic signal for the oncoming traffic lane,
a determination unit configured to determine, based on at least the display state of the traffic signal for the oncoming traffic lane that is recognized in the waiting state, whether or not a turning operation across the oncoming traffic lane is possible, and
an information presentation unit configured to present information corresponding to the result of the determination to a driver.

2. The driving assistance apparatus according to claim 1, wherein the determination unit is configured to further perform the determination based on whether or not an oncoming vehicle entering the intersection is present in the oncoming traffic lane.

3. The driving assistance apparatus according to claim 1, wherein the determination unit is further configured to perform the determination based on the speed of the oncoming vehicle in the oncoming traffic lane.

4. The driving assistance apparatus according to claim 1, further comprising at least one processor or circuit configured to function as:
a control unit configured to change the angle of view of the rearward image capturing apparatus depending on whether the vehicle is in a waiting state or not.

5. The driving assistance apparatus according to claim 1, wherein the rearward image capturing apparatus includes a first rearward image capturing apparatus capable of capturing an image of a traffic signal for an oncoming traffic lane in the waiting state, and
a second rearward image capturing apparatus having a different angle of view from that of the first rearward image capturing apparatus,
wherein the information presentation unit is configured to display an image of the second rearward image capturing apparatus in a case in which it is not in the waiting state.

6. The driving assistance apparatus according to claim 1, wherein the image recognition unit is further configured to recognize a display state of the traffic signal for the traveling lane based on the image of the traffic signal for the traveling lane that has been captured by a forward image capturing apparatus.

7. The driving assistance apparatus according to claim 6, wherein the determination unit is further configured to perform the determination based on the display status of the traffic signal for the traveling lane.

8. The driving assistance apparatus according to claim 6, wherein the forward image capturing apparatus and the rearward image capturing apparatus include an image capturing apparatus that is capable of capturing both forward and rearward images.

9. The driving assistance apparatus according to claim 1, further comprising at least one processor or circuit configured to function as:
a travel environment determination unit configured to determine whether or not the vehicle is in a waiting state at an intersection.

10. A driving assistance method comprising:
an image recognition step of acquiring an image of a traffic signal for an oncoming traffic lane from a rearward image capturing apparatus for capturing an image rearward of a vehicle, and in a case in which the vehicle is in a waiting state for turning across an oncoming traffic lane at an intersection, recognizing a display state of the traffic signal for the oncoming traffic lane based on an image of the traffic signal for the oncoming traffic lane,
a determination step of determining, based on at least the display state of the traffic signal for the oncoming traffic lane that is recognized in the waiting state, whether or not a turning operation across the oncoming traffic lane is possible, and
an information presentation step of presenting information corresponding to the result of the determination to the driver.

11. A non-transitory computer-readable storage medium configured to store a computer program comprising instructions for executing following processes:
an image recognition step of acquiring an image of a traffic signal for an oncoming traffic lane from a rearward image capturing apparatus for capturing an image rearward of a vehicle, and in a case in which the vehicle is in a waiting state for turning across an oncoming traffic lane at an intersection, recognizing a display state of the traffic signal for the oncoming traffic lane based on an image of the traffic signal for the oncoming traffic lane,
a determination step of determining, based on at least the display state of the traffic signal for the oncoming traffic lane that is recognized in the waiting state, whether or not a turning operation across the oncoming traffic lane is possible, and
an information presentation step of presenting information corresponding to the result of the determination to the driver.
